(19) United States
(12) Patent Application Publication
(10) Pub. No.: US 2020/0389071 A1
(43) Pub. Date: Dec. 10, 2020

(54) ROTARY ELECTRIC MACHINE

(71) Applicant: HONDA MOTOR CO., LTD., Tokyo (JP)

(72) Inventors: Manabu Sakurada, Wako-shi (JP); Koji Kuroda, Wako-shi (JP)

(21) Appl. No.: 15/930,548

(22) Filed: May 13, 2020

(30) Foreign Application Priority Data
May 16, 2019 (JP) 2019-092820

(51) Int. Cl. H02K 9/193; H02K 1/18; H02K 5/20

(52) U.S. Cl. CPC H02K 9/193; H02K 5/20; H02K 1/185

(57) ABSTRACT

A rotary electric machine includes a stator, a rotor, a stator holder, a housing, a cooling liquid introduction room, and a plurality of seal members. One of an outer circumferential surface of the stator holder and an inner circumferential surface of the circumferential wall part of the housing includes a seal hold part that holds the plurality of seal members. Another of the outer circumferential surface of the stator holder and the inner circumferential surface of the circumferential wall part includes a plurality of raised parts on which the plurality of seal members held by the seal hold part ride and with which the plurality of seal members come into close contact in a compressed state. An end portion on one side in the axial direction of at least two of the raised parts and any of the seal members held by the seal hold part are arranged at a position so as not to come into contact with each other simultaneously on a virtual relative displacement trajectory in the axial direction of the circumferential wall part and the stator holder.

### CROSS-REFERENCE TO RELATED APPLICATION

Priority is claimed on Japanese Patent Application No. 2019-092820, filed on May 16, 2019, the contents of which are incorporated herein by reference.

### BACKGROUND

### Field of the Invention

The present invention relates to a rotary electric machine mounted on a vehicle or the like.

### Background

As a rotary electric machine mounted on a vehicle or the like, such a machine is known which includes a rotor that is rotated integrally with a rotation shaft and a stator that is arranged radially outside the rotor, wherein a plurality of permanent magnets are arranged on an outer circumference of the rotor, and a coil is wound around the stator. In this type of rotary electric machine, a coil part of the stator easily generates heat during operation.

As a countermeasure, a rotary electric machine is proposed in which a cylindrical stator holder that holds a stator is fixed to an inner circumferential surface of a circumferential wall part of a housing by a press fit or the like, and a cooling liquid introduction room is formed between an outer circumferential surface of the stator holder and the circumferential wall part of the housing (for example, refer to Japanese Unexamined Patent Application, First Publication No. 2013-90488).

In the rotary electric machine described in Japanese Unexamined Patent Application, First Publication No. 2013-90488, the cooling liquid introduction room is formed between the outer circumferential surface of the stator holder and an inner circumferential surface of the circumferential wall part of the housing, and by allowing a cooling liquid to flow through the cooling liquid introduction room, the heat of the stator due to a coil is absorbed. Further, a seal member for preventing a leakage of the cooling liquid from the cooling liquid introduction room is provided between the outer circumferential surface of the stator holder and the inner circumferential surface of the circumferential wall part of the housing.

### SUMMARY

In this type of rotary electric machine, in a case where a plurality of seal members are provided between the stator holder and the circumferential wall part of the housing, the stator holder is pressed into the inner circumferential surface of the circumferential wall part of the housing at the time of manufacturing, for example, in a state where a plurality of seal members are mounted on the outer circumferential surface of the stator holder in advance. In this case, when the number of seal members provided between the stator holder and the circumferential wall part of the housing is increased, a press load of the stator holder with respect to the housing is increased, and an assembly work of components becomes difficult.

An aspect of the present invention provides a rotary electric machine in which a stator holder can be easily assembled to a housing even if the rotary electric machine has a structure in which a plurality of seal members are provided between the stator holder and a circumferential wall part of the housing.

A rotary electric machine according to an aspect of the present invention includes: a stator; a rotor that is rotated relative to the stator; a stator holder that has a substantially cylindrical shape and that holds the stator at an inner circumferential side; a housing that has a circumferential wall part at an inner circumferential side into which the stator holder is fitted and that covers outsides of the stator, the rotor, and the stator holder; a cooling liquid introduction room that is formed between the stator holder and the circumferential wall part; and a plurality of seal members that are arranged in an outer region of the cooling liquid introduction room with respect to an axial direction of the stator holder between the stator holder and the circumferential wall part, wherein one of an outer circumferential surface of the stator holder and an inner circumferential surface of the circumferential wall part includes a seal hold part that holds the plurality of seal members, another of the outer circumferential surface of the stator holder and the inner circumferential surface of the circumferential wall part includes a plurality of raised parts on which the plurality of seal members held by the seal hold part ride and with which the plurality of seal members come into close contact in a compressed state, and an end portion on one side in the axial direction of at least two of the raised parts and any of the seal members held by the seal hold part are arranged at a position so as not to come into contact with each other simultaneously on a virtual relative displacement trajectory in the axial direction of the circumferential wall part and the stator holder.

According to the above configuration, when the stator holder is fitted into the circumferential wall part of the housing in a direction in which the seal member rides on the raised part from an end portion on one side in the axial direction of the raised part in a state where the seal member is mounted on the seal hold part, all of the seal members do not ride simultaneously on the end portion on the one side in the axial direction of the raised part in the fit process. When the stator holder is fitted into the circumferential wall part of the housing, a large insertion load is required when the seal member rides on the end portion of the raised part. Therefore, in a situation where all of the seal members ride on the end portion of the raised part simultaneously, the required insertion load is increased depending on the number of seal members that simultaneously ride. However, in a case of the rotary electric machine having the above configuration, since all of the seal members do not ride on the end portion of the raised part simultaneously, it is possible to reduce the required insertion load.

In each of a first region between the stator holder and the circumferential wall part, the first region being an outer region on the one side in the axial direction of the cooling liquid introduction room, and a second region between the stator holder and the circumferential wall part, the second region being an outer region on another side in the axial direction of the cooling liquid introduction room, the pair of seal members may be spaced apart in the axial direction and be held by each of the seal hold members, and the pair of raised parts with which each of the seal members comes into close contact may be arranged, and an end portion on one side in the axial direction of all of the raised parts and all of the seal members held by the seal hold part may be arranged at a position so as not to come into contact with each other simultaneously on the virtual relative displacement trajectory in the axial direction of the circumferential wall part and the stator holder.

In this case, when the stator holder is fitted into the circumferential wall part of the housing in a direction in which the seal member rides on the raised part from the end portion on the one side in the axial direction of the raised part in a state where the pair of seal members are mounted on each of the seal hold parts in the first region and the second region, two or more of the seal members do not ride simultaneously on the end portion on the one side in the axial direction of the raised part in the fit process. Therefore, although the rotary electric machine has a structure in which four seal members are provided between the inner circumferential surface of the circumferential wall part and the outer circumferential surface of the stator holder, it is possible to assemble the stator holder to the circumferential wall part of the housing with a relatively small force.

According to the aspect of the present invention, when the stator holder is fitted into the circumferential wall part of the housing, all of the seal members do not ride simultaneously on the end portion on the one side in the axial direction of the raised part, and therefore, even if the rotary electric machine has a structure in which the plurality of seal members are provided between the stator holder and the circumferential wall part of the housing, it is possible to easily assemble the stator holder to the housing.

### BRIEF DESCRIPTION OF THE DRAWINGS

FIG. 1 is a longitudinal cross-sectional view of a rotary electric machine according to an embodiment.

FIG. 2 is an enlarged cross-sectional view showing part of FIG. 1.

FIG. 3 is a further enlarged cross-sectional view showing part of FIG. 2.

FIG. 4A to FIG. 4C are cross-sectional views showing a collapsed state of a seal member at the time of assembly according to the embodiment.

FIG. 5A to FIG. 5F are cross-sectional views showing a fit process of a stator holder with respect to a housing sequentially in the order of FIG. 5A to FIG. 5F according to the embodiment.

FIG. 6 is a graph showing a change of an insertion load when the stator holder is fitted into the housing according to the embodiment.

### DESCRIPTION OF THE EMBODIMENTS

Hereinafter, an embodiment of the present invention will be described with reference to the drawings.

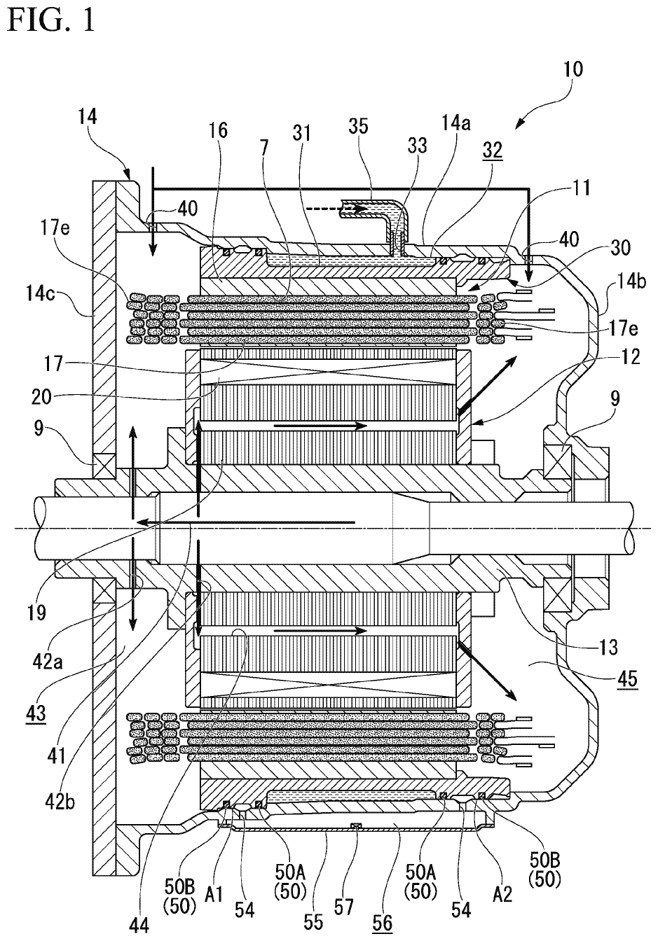

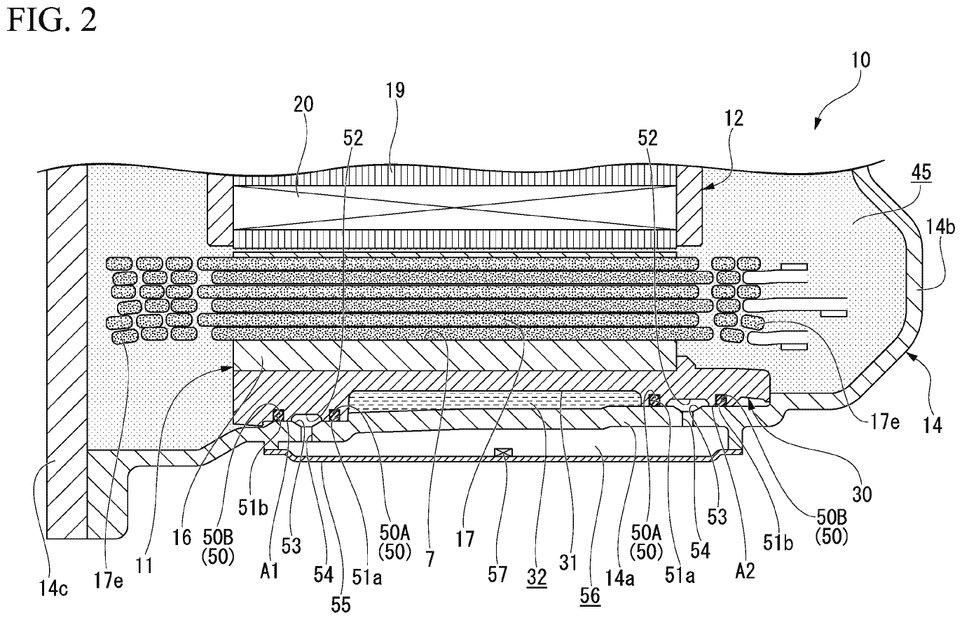

FIG. 1 is a longitudinal cross-sectional view showing a cross-section along an axial direction of a rotary electric machine 10 according to the present embodiment. FIG. 2 is an enlarged longitudinal cross-sectional view showing a lower end part of the rotary electric machine 10.

The rotary electric machine 10 of the present embodiment is used, for example, for a drive source of an electric vehicle. The rotary electric machine 10 includes a stator 11 that generates a rotation magnetic field, a rotor 12 that is rotated in response to the rotation magnetic field generated at the stator 11, a rotation shaft 13 that is coaxially provided on the rotor 12, and a housing 14 that internally holds the stator 11 and that covers outsides of the stator 11 and the rotor 12.

The stator 11 includes a stator core 16 having a substantially cylindrical shape and formed of a plurality of laminated electromagnetic steel plates and a coil 17 (electric power distribution coil) that is wound around an edge part on an inner circumferential side of the stator core 16. The coil 17 is constituted of a three-phase coil of the U phase, the V phase, and the W phase. The coil 17 of the present embodiment is constituted of segment coils that are mutually connected and used. The segment coil is constituted of a segment conductor having a pair of insertion parts inserted into a slot 7 of the stator core 16 and a folding connection portion that connects together the insertion parts. An end portion on the opposite side of the folding connection portion of the pair of insertion parts is a connection portion connected to another adjacent segment conductor.

In the coil 17, the connection portion of each segment conductor is arranged on one end side in the axial direction of the stator 11, and the folding connection portion is arranged on another end side in the axial direction of the stator 11. The connection portion and the folding connection portion protrude outward (is exposed to the outside) from each end part in the axial direction of the stator 11. An external electric power line is connected to the end part of the coil 17. A current is distributed to the coil 17 via the electric power line.

The rotor 12 includes a rotor core 19 integrally joined to an outer surface of the rotation shaft 13 and a plurality of permanent magnets 20 arranged on an outer circumferential edge part of the rotor core 19 to be spaced apart from each other in a circumferential direction. The rotor core 19 is formed in a substantially cylindrical form by laminating a plurality of electromagnetic steel plates. The rotation shaft 13 is rotatably supported by the housing 14 via a bearing 9. The rotor 12 is rotated in response to the rotation magnetic field of the stator 11, and thereby, the rotation shaft 13 is rotated integrally with the rotor 12.

The housing 14 includes a circumferential wall part 14a that covers an outer circumferential side of the stator core 16 and a pair of side wall parts 14b, 14c that are continuously connected to an end portion on both sides in the axial direction of the circumferential wall part 14a and that cover an outside part in the axial direction of the rotor 12 and a coil end 17e (an end part of the coil 17 exposed from an end surface in the axial direction of the stator 11) of the coil 17. A stator holder 30 having a substantially cylindrical shape is attached integrally to an outer circumferential surface of the stator core 16 of the stator 11. The stator holder 30 is fitted into and fixed to the inner circumferential surface of the circumferential wall part 14a of the housing 14. An annular groove 31 elongated in the axial direction is formed on an outer circumferential surface of the stator holder 30. The annular groove 31 of the stator holder 30 constitutes a cooling liquid introduction room 32 between the annular groove 31 and the circumferential wall part 14a in a state where the stator holder 30 is attached to the circumferential wall part 14a of the housing 14. The cooling liquid introduction room 32 is formed in a cylindrical shape substantially along the outer circumferential surface of the stator 11.

A flow-in port 33 for allowing the cooling liquid to flow into the cooling liquid introduction room 32 is formed on an upper side of the circumferential wall part 14a of the housing 14. A flow-out port (not shown) for allowing the cooling liquid to flow out from the cooling liquid introduction room 32 to the outside is formed on a lower side of the circumferential wall part 14a. An introduction piping 35 for introducing the cooling liquid from a pump (not shown) to the cooling liquid introduction room 32 is connected to the flow-in port 33. A return piping (not shown) for allowing the cooling liquid to return to the pump from the cooling liquid introduction room 32 is connected to the flow-out port.

Further, a lubricating liquid supply hole 40 for dropping the lubricating liquid to the coil end 17e of the coil 17 to cool the coil end 17e and then supplying the dropped lubricating liquid to a lubrication required area such as the bearing 9 is formed on an upper portion of the circumferential wall part 14a of the housing 14. The lubricating liquid supply hole 40 is formed on the circumferential wall part 14a at a position directly above the coil end 17e on one end side in the axial direction and at a position directly above the coil end 17e on another end side in the axial direction.

An in-shaft passage 41 is provided on the rotation shaft 13 along a shaft center of the rotation shaft 13. Branch passages 42a, 42b that allow the in-shaft passage 41 and an internal space of the housing 14 to communicate with each other is formed on the rotation shaft 13. One branch passage 42a communicates with a first lubricating liquid introduction room 43 (lubricating liquid introduction room) that faces one end side in the axial direction of the stator 11 and the rotor 12 in the housing 14. The other branch passage 42b communicates via an inner passage 44 of the rotor core 19 with a second lubricating liquid introduction room 45 (lubricating liquid introduction room) that faces another end side in the axial direction of the stator 11 and the rotor 12 in the housing 14. The in-shaft passage 41 of the rotation shaft 13 is connected to a supply device of the lubricating liquid. The lubricating liquid introduced into the in-shaft passage 41 is discharged through the branch passages 42a, 42b to the first lubricating liquid introduction room 43 and the second lubricating liquid introduction room 45.

The lubricating liquid introduced to the first lubricating liquid introduction room 43 and the second lubricating liquid introduction room 45 cools the rotor 12 and the stator 11 and is supplied to the lubrication required area in the housing 14 such as the bearing 9. The lubricating liquid dropped from each lubricating liquid supply hole 40 of the circumferential wall part 14a of the housing 14 is also introduced to the first lubricating liquid introduction room 43 and the second lubricating liquid introduction room 45. The lubricating liquid flowing into the first lubricating liquid introduction room 43 and the second lubricating liquid introduction room 45 returns to the supply device through a discharge passage (not shown) provided on the lower side of the housing 14.

A seal pair 50 constituted of seal members 50A, 50B is assembled to an outer circumferential surface of the stator holder 30 at each of positions on both sides in the axial direction that sandwich the annular groove 31 (cooling liquid introduction room 32). Both seal members 50A, 50B are formed in an annular shape and are in close contact with an inner circumferential surface of the circumferential wall part 14a in a state where the stator holder 30 is assembled to the inner circumferential surface of the circumferential wall part 14a of the housing 14. The seal member 50A of each seal pair 50 is arranged at an axially inward position (at a position close to the cooling liquid introduction room) of the stator holder 30. The seal member 50B of each seal pair 50 is arranged at an axially outward position (at a position close to the lubricating liquid introduction room) of the stator holder 30. The seal members 50A, 50B of each seal pair 50 are aligned in the axial direction and in contact with the inner circumferential surface of the circumferential wall part 14a.

As shown in FIG. 2 in an enlarged manner, a first annular groove 51a and a second annular groove 51b are formed to be spaced apart from each other in the axial direction of the stator holder 30 at positions on both sides in the axial direction of the outer circumferential surface of the stator holder 30. The seal member 50A is assembled to the first annular groove 51a. The seal member 50B is assembled to the second annular groove 51b. A recess part 52 having an annular shape is formed along an outer circumference of the stator holder 30 on the outer circumferential surface of the stator holder 30 between a formation part of the first annular groove 51a and a formation part of the second annular groove 51b.

The seal pair 50 (the seal members 50A, 50B) assembled to one end part side in the axial direction of the stator holder 30 is in close contact with the inner circumferential surface of the circumferential wall part 14a in a region (hereinafter, referred to as a “first region A1”) close to one end part in the axial direction of the circumferential wall part 14a of the housing 14. The seal pair 50 (the seal members 50A, 50B) assembled to another end part side in the axial direction of the stator holder 30 is in close contact with the inner circumferential surface of the circumferential wall part 14a in a region (hereinafter, referred to as a “second region A2”) close to another end part in the axial direction of the circumferential wall part 14a of the housing 14. The seal member 50A regulates the leakage of the cooling liquid from the cooling liquid introduction room 32 to a lubricating liquid introduction room direction (a direction of the first lubricating liquid introduction room 43 or a direction of the second lubricating liquid introduction room 45). The seal member 50B regulates the leakage of the lubricating liquid from the lubricating liquid introduction room (the first lubricating liquid introduction room 43 or the second lubricating liquid introduction room 45) to a cooling liquid introduction room 32 direction.

A recess part 53 having an annular shape is formed between a contact position of the seal member 50A and a contact position of the seal member 50B in the first region A1 and the second region A2 of the circumferential wall part 14a. A leakage liquid discharge hole 54 that radially penetrates through a wall of the circumferential wall part 14a is formed in a vertically lower region of the circumferential wall part 14a of the recess part 53 having an annular shape. The leakage liquid discharge hole 54 allows a bottom portion in the recess part 53 and the outside of the circumferential wall part 14a (the housing 14) to communicate with each other. The cooling liquid that is leaked through the seal member 50A from the cooling liquid introduction room 32 is discharged to the outside of the circumferential wall part 14a via the leakage liquid discharge hole 54 and the recess part 53. Similarly, the lubricating liquid that is leaked through the seal member 50B from the first lubricating liquid introduction room 43 or the second lubricating liquid introduction room 45 is discharged to the outside of the circumferential wall part 14a via the leakage liquid discharge hole 54 and the recess part 53.

A bottom lid 55 is attached to a lower surface of the circumferential wall part 14a (the housing 14). A leakage liquid flow-in room 56 is formed between the bottom lid 55 and the lower surface of the circumferential wall part 14a. A leakage liquid (the cooling liquid or the lubricating liquid) discharged to the outside of the circumferential wall part 14a (the housing 14) through the leakage liquid discharge hole 54 flows into the leakage liquid flow-in room 56. The bottom lid 55 is detachably attached to the lower surface of the circumferential wall part 14a by a bolting or the like. A sensor 57 for detecting the flow-in of the leakage liquid is arranged in the leakage liquid flow-in room 56. The sensor 57 is connected to a signal input part of a control circuit (not shown). The control circuit is, for example, electrically connected to an alarm display lamp and turns on the alarm lamp when the sensor 57 detects that the leakage liquid has flowed in the leakage liquid flow-in room 56.

In the rotary electric machine 10 of the present embodiment, the heat of the stator 11 due to the heat generation of the coil 17 is cooled by the cooling liquid through the stator holder 30 by the introduction of the cooling liquid into the cooling liquid introduction room 32 in the housing 14. Further, by the introduction of the lubricating liquid into the first lubricating liquid introduction room 43 and the second lubricating liquid introduction room 45 in the housing 14, the lubrication required area such as the bearing 9 in the housing 14 is lubricated, and the rotor 12, the coil end 17e of the stator 11, or the like is cooled by the lubricating liquid.

Further, a space between the inner surface of the circumferential wall part 14a of the housing 14 and the outer circumferential surface of the stator holder 30 is sealed by the seal pair 50 constituted of the seal members 50A, SOB in the first region A1 and the second region A2. Thereby, the mutual inflow of the cooling liquid and the lubricating liquid between the cooling liquid introduction room 32 and the first lubricating liquid introduction room 43 and between the cooling liquid introduction room 32 and the second lubricating liquid introduction room 45 is regulated.

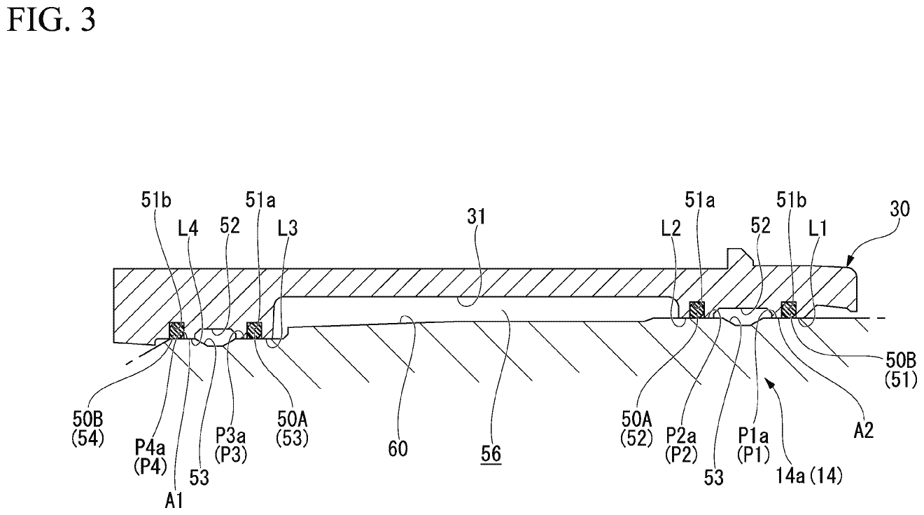

Next, a detailed structure of an assembly part between the stator holder 30 and the circumferential wall part 14a of the housing 14 will be described. FIG. 3 is an enlarged cross-sectional view showing the assembly part between the housing 14 and stator holder 30 of FIG. 2.

As shown in FIG. 3, an outer diameter (an outer diameter of a portion that constitutes a side edge part of the first annular groove 51a and a portion that constitutes a side edge part of the second annular groove 51b) in the first region A1 of the stator holder 30 is set to be larger than an outer diameter (an outer diameter of a portion that constitutes a side edge part of the first annular groove 51a and a portion that constitutes a side edge part of the second annular groove 51b) in the second region A2 of the stator holder 30. In the present embodiment, the first annular groove 51a and the second annular groove 51b constitute a seal hold part.

Hereinafter, for ease of explanation, part of the outer circumferential surface of the stator holder 30 that constitutes the side edge part of the second annular groove 51b in the second region A2 is referred to as a first land part L1, and part of the outer circumferential surface of the stator holder 30 that constitutes the first annular groove 51a in the second region A2 is referred to as a second land part L2. Part of the outer circumferential surface of the stator holder 30 that constitutes the side edge part of the first annular groove 51a in the first region A1 is referred to as a third land part L3, and part of the outer circumferential surface of the stator holder 30 that constitutes the second annular groove 51b in the first region A1 is referred to as a fourth land part L4.

Further, when distinguishing the four seal members, the seal member 50B arranged on the first land part L1 is referred to as a first seal S1, the seal member 50A arranged on the second land part L2 is referred to as a second seal S2, the seal member 50A arranged on the third land part L3 is referred to as a third seal S3, and the seal member 50B arranged on the fourth land part L4 is referred to as a fourth seal S4.

A first raised part P1 which the first land part L1 and the first seal S1 on the stator holder 30 side are arranged to face and a second raised part P2 which the second land part L2 and the second seal S2 on the stator holder 30 side are arranged to face are formed on the inner circumferential surface of the circumferential wall part 14a of the housing 14 on the second region A2 side. The first raised part P1 and the second raised part P2 are raised in an annular shape along the inner circumferential surface of the circumferential wall part 14a. The recess part 53 having an annular shape described above is formed between the first raised part P1 and the second raised part P2.

A third raised part P3 which the third land part L3 and the third seal S3 on the stator holder 30 side are arranged to face and a fourth raised part P4 which the fourth land part L4 and the fourth seal S4 on the stator holder 30 side are arranged to face are formed on the inner circumferential surface of the circumferential wall part 14a of the housing 14 on the first region A1 side. The third raised part P3 and the fourth raised part P4 are raised in an annular shape along the inner circumferential surface of the circumferential wall part 14a. The recess part 53 having an annular shape described above is also formed between the third raised part P3 and the fourth raised part P4.

An inner diameter (an inner diameter of each of top surfaces P3a, P4a of the third raised part P3 and the fourth raised part P4) of the circumferential wall part 14a in the first region A1 is set to be larger than an inner diameter (an inner diameter of each of top surfaces P1a, P2a of the first raised part P1 and the second raised part P2) of the circumferential wall part 14a in the second region A2. In the present embodiment, the first raised part P1, the second raised part P2, the third raised part P3, and the fourth raised part P4 constitute a plurality of raised parts on which the seal member rides and with which the seal member comes into close contact in a compressed state.

A middle region in the axial direction of the inner circumferential surface of the circumferential wall part 14a is defined as a middle inner diameter part 60 that expands radially inward in a stepped form with respect to the third raised part P3 and that extends to the second raised part P2 while maintaining a substantially constant inner diameter. The middle inner diameter part 60 together with a portion of each of the third raised part P3 and the second raised part P2 constitute an outer circumferential surface of the cooling liquid introduction room 32. The inner diameters of the middle inner diameter part 60 and the third and fourth raised parts P3, P4 are set to be larger than the outer diameters of the first and second land parts L1, L2 of the stator holder 30.

In the rotary electric machine 10 of the present embodiment, an end part (right end part in FIG. 3) on the second region A2 side of the stator holder 30 is inserted from the first region A1 side of the circumferential wall part 14a to the inner circumferential surface of the circumferential wall part 14a and is fitted directly to the inside of the circumferential wall part 14a. In the fit process, the first and second land parts L1, L2 of the stator holder 30 can be inserted smoothly to the position of the second raised part P2 according to the above-described dimensional relationship between the inner diameters of the middle inner diameter part 60 and the third and fourth raised parts P3, P4 and the outer diameters of the first and second land parts L1, L2.

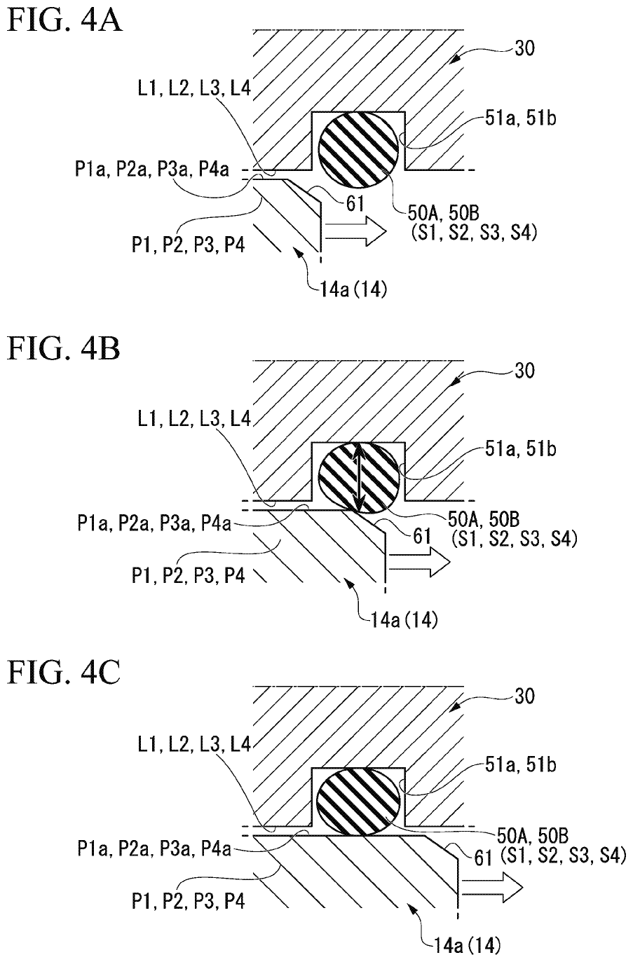

FIG. 4A to FIG. 4C are cross-sectional views showing a collapsed state of the seal members 50A, 50B (the first seal S1, the second seal S2, the third seal S3, and the fourth seal S4) when the stator holder 30 is fitted to the circumferential wall part 14a of the housing 14 during assembly of the rotary electric machine 10. FIGS. 4A, 4B, and 4C show, in this order, the progress of the fitting of the stator holder 30 and the change of the collapsed state of the seal members 50A, 50B when the stator holder 30 is fitted to the circumferential wall part 14a. The reference numeral 61 in FIG. 4 represents a chamfered part that is provided in a tapered shape on an end portion (hereinafter, referred to as “an end portion on one side in an axial direction”) on a side which the stator holder 30 enters of the raised part (the first raised part P1, the second raised part P2, the third raised part P3, and the fourth raised part P4) on the circumferential wall part 14a side.

As shown in FIG. 4A, an insertion load associated with the collapse of the seal members 50A, 50B (the first seal S1, the second seal S2, the third seal S3, and the fourth seal S4) is not generated while the raised part (the first raised part P1, the second raised part P2, the third raised part P3, and the fourth raised part P4) on the circumferential wall part 14a side is not in contact with the seal members 50A, 50B (the first seal S1, the second seal S2, the third seal S3, and the fourth seal S4).

On the other hand, as shown in FIG. 4B, when the end portion on one side in the axial direction of the raised part (the first raised part P1, the second raised part P2, the third raised part P3, and the fourth raised part P4) comes into contact with the seal members 50A, 50B (the first seal S1, the second seal S2, the third seal S3, and the fourth seal S4) and presses and deforms the seal members 50A, 50B (the first seal S1, the second seal S2, the third seal S3, and the fourth seal S4), the insertion load associated with the collapse of the seal members 50A, 50B (the first seal S1, the second seal S2, the third seal S3, and the fourth seal S4) is maximized Δt this time, the seal members 50A, 50B (the first seal S1, the second seal S2, the third seal S3, and the fourth seal S4) ride on the top surfaces P1a, P2a, P3a, and P4a of the raised part (the first raised part P1, the second raised part P2, the third raised part P3, and the fourth raised part P4) via the chamfered part 61.

Further, as shown in FIG. 4C, after the seal members 50A, 50B (the first seal S1, the second seal S2, the third seal S3, and the fourth seal S4) ride on the top surfaces P1a, P2a, P3a, and P4a, the insertion load is decreased compared to when riding on the top surfaces P1a, P2a, P3a, and P4a.

In the rotary electric machine 10 of the present embodiment, in light of the above-described consideration, when the stator holder 30 is fitted to the circumferential wall part 14a of the housing 14 during assembly, each part is set such that the end portion on one side in the axial direction of two or more raised parts (the first raised part P1, the second raised part P2, the third raised part P3, and the fourth raised part P4) does not come into contact with any of the seal members 50A, 50B (the first seal S1, the second seal S2, the third seal S3, and the fourth seal S4) simultaneously.

That is, in the present embodiment, the end portion on the one side in the axial direction of all of the raised parts (the first raised part P1, the second raised part P2, the third raised part P3, and the fourth raised part P4) and all of the seal members 50A, 50B (the first seal S1, the second seal S2, the third seal S3, and the fourth seal S4) held by the seal hold part (the first annular groove 51a and the second annular groove 51b) are arranged at a position so as not to come into contact with each other simultaneously on a virtual relative displacement trajectory in the axial direction of the circumferential wall part 14a and the stator holder 30. The term “virtual relative displacement trajectory” means a trajectory of virtual displacement in a case where the stator holder 30 is assumed to displace from a fit start position to a fit complete position relative to the circumferential wall part 14a. On the trajectory of virtual displacement, the end part on the one side in the axial direction of two or more raised parts (the first raised part P1, the second raised part P2, the third raised part P3, and the fourth raised part P4) does not come into contact with any of the seal members 50A, 50B (the first seal S1, the second seal S2, the third seal S3, and the fourth seal S4) simultaneously.

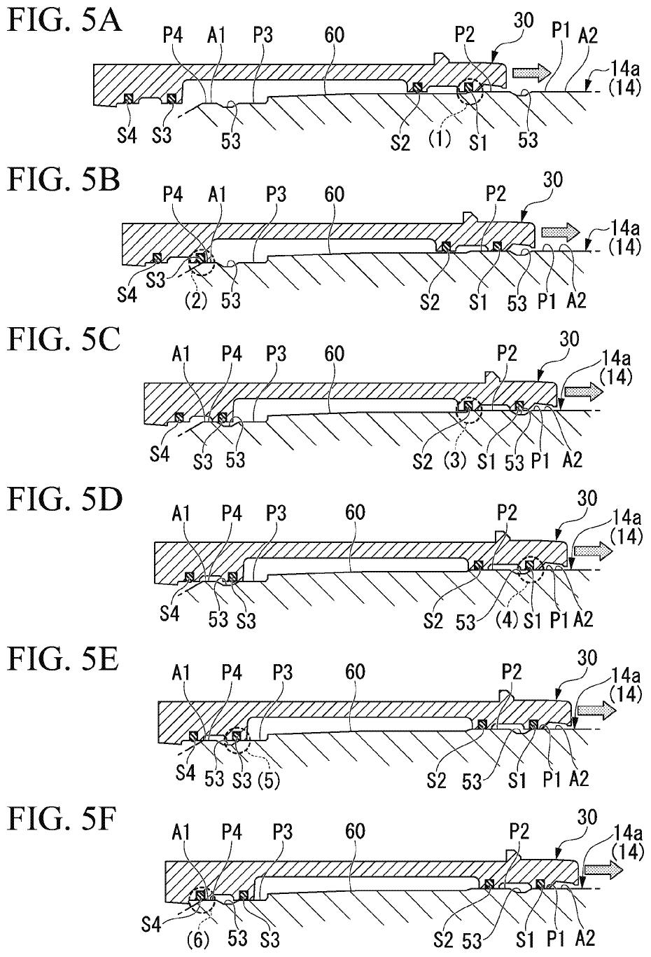

FIGS. 5A to 5F are cross-sectional views showing a fit process of fitting the stator holder 30 into the circumferential wall part 14a of the housing 14 in the order of FIG. 5A to FIG. 5F.

FIG. 5A shows a state in which the fitting of the stator holder 30 to the circumferential wall part 14a is started, and the first seal S1 on the second region A2 side of the stator holder 30 rides on an end portion on one side in the axial direction of the second raised part P2 at the part (1) in FIG. 5A. At this time, the other seal members (S2, S3, S4) are not in contact with any of the raised parts.

FIG. 5B shows a state in which, after the first seal S1 on the second region A2 side rides on the second raised part P2 of the circumferential wall part 14a, the third seal S3 on the first region A1 side rides on an end portion on the one side in the axial direction of the fourth raised part P4 at the part indicated by (2) in FIG. 5B. At this time, the second seal S2 and the fourth seal S4 are not in contact with any of the raised parts.

FIG. 5C shows a state in which, in a situation where the first seal S1 passes through the recess part 53 on the second region A2 side and the third seal S3 passes through the recess part 53 on the first region A1 side, the second seal S2 on the second region A2 side rides on the end portion on the one side in the axial direction of the second raised part P2 at the part indicated by (3) in FIG. 5C. At this time, the fourth seal S4 is not in contact with any of the raised parts.

FIG. 5D shows a state in which, in a situation where the third seal S3 passes through the recess part 53 on the first region A1 side after the second seal S2 rides on the second raised part P2, the first seal S1 on the first region A side rides on an end portion on the one side in the axial direction of the first raised part P1 at the part indicated by (4) in FIG. 5D. At this time, the fourth seal S4 is not in contact with any of the raised parts.

FIG. 5E shows a state in which, after the second seal S2 rides on the second raised part P2 and the first seal S1 rides on the first raised part P1, the third seal S3 on the first region A1 side rides on an end portion on the one side in the axial direction of the third raised part P3 at the part indicated by (5) in FIG. 5E. At this time, the fourth seal S4 is not in contact with any of the raised parts.

FIG. 5F shows a state in which, after the first seal S1 and the second seal S2 ride on the first raised part P1 and the second raised part P2 respectively, and the third seal S3 rides on the third raised part P3, the fourth seal S4 on the first region A1 side rides on the end portion on the one side in the axial direction of the fourth raised part P4 at the part indicated by (6) in FIG. 5F.

When the stator holder 30 is further fitted into the circumferential wall part 14a from this state, as shown in FIG. 3, all of the seals (S1, S2, S3, S4) ride on the corresponding raised part (P1, P2, P3, P4), and the fit process of the stator holder 30 is ended.

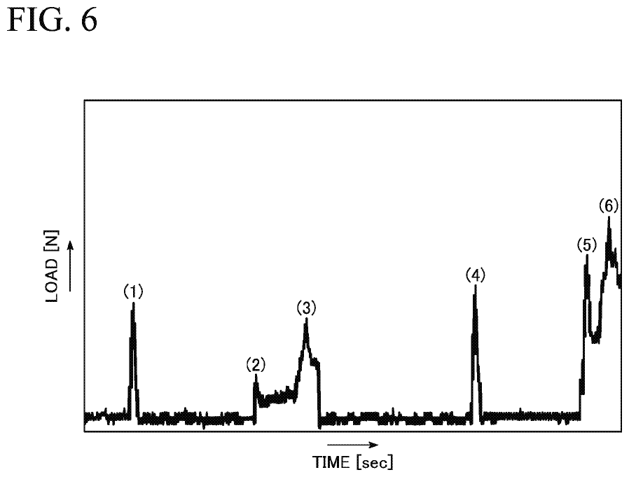

FIG. 6 is a graph showing a change of the insertion load when the stator holder 30 is fitted into the housing 14 as shown in FIGS. 5A to 5F. The signs (1), (2), (3), (4), (5), and (6) in FIG. 6 are peaks of the insertion load in the respective steps of FIGS. 5A, 5B, 5C, 5D, 5E, and 5F.

In the present embodiment, since two or more seals (51, S2, S3, S4) do not ride on the end portion on the one side in the axial direction of the different raised part (P1, P2, P3, P4) simultaneously, the peak of the insertion load does not become extremely large at one part as shown in FIG. 6.

As described above, in the rotary electric machine 10 of the present embodiment, the end portion on the one side in the axial direction of all of the raised parts (the first raised part P1, the second raised part P2, the third raised part P3, and the fourth raised part P4) on the housing 14 side and all of the seal members 50A, 50B (the first seal S1, the second seal S2, the third seal S3, and the fourth seal S4) on the stator holder 30 side are arranged at a position so as not to come into contact with each other simultaneously on the virtual relative displacement trajectory in the axial direction of the circumferential wall part 14a and the stator holder 30. Therefore, when the stator holder 30 is fitted into the circumferential wall part 14a of the housing 14 during assembly of the rotary electric machine 10, two or more seal members 50A, 50B (the first seal S1, the second seal S2, the third seal S3, and the fourth seal S4) do not simultaneously ride on the end portion on the one side in the axial direction of the raised part (the first raised part P1, the second raised part P2, the third raised part P3, and the fourth raised part P4).

Accordingly, although the rotary electric machine 10 of the present embodiment has a structure in which the four seal members 50A, 50B (the first seal S1, the second seal S2, the third seal S3, and the fourth seal S4) are provided between the circumferential wall part 14a of the housing 14 and the outer circumferential surface of the stator holder 30, it is possible to assemble the stator holder 30 to the circumferential wall part 14a of the housing 14 with a relatively small force.

Here, in the embodiment described above, the end portion on one side in the axial direction of all of the raised parts (P1, P2, P3, P4) on the housing 14 side and all of the seal members 50A, 50B (51, S2, S3, S4) on the stator holder 30 side are arranged at a position so as not to come into contact with each other simultaneously on the virtual relative displacement trajectory of the circumferential wall part 14a and the stator holder 30.

However, it is possible to obtain an advantage to some extent if the end portion on one side in the axial direction of at least two of the raised parts (P1, P2, P3, P4) and any of the seal members (51, S2, S3, S4) on the stator holder 30 side are arranged at a position so as not to come into contact with each other simultaneously on the virtual relative displacement trajectory of the circumferential wall part 14a and the stator holder 30. That is, in such a configuration, since all of the seal members (51, S2, S3, S4) do not ride on the end portion on the one side in the axial direction of the raised part (P1, P2, P3, P4) simultaneously at the time of assembly, it is possible to reduce the insertion load of the stator holder 30.

The present invention is not limited to the embodiment described above, and various design changes can be made without departing from the scope of the invention. For example, in the embodiment described above, a plurality of seal members 50A, 50B (S1, S2, S3, S4) are held on the outer circumferential surface side of the stator holder 30, and a plurality of raised parts (P1, P2, P3, P4) are provided on the inner circumferential surface side of the circumferential wall part 14a of the housing 14; however, conversely, a plurality of seal members can be held on the inner circumferential surface side of the circumferential wall part of the housing, and a plurality of raised parts can be formed on the outer circumferential surface side of the stator holder. Further, the number of seal members provided between the stator holder and the circumferential wall part of the housing is not limited to four and may be arbitrary as far as the number is two or more.

What is claimed is:

1. A rotary electric machine comprising:
a stator;
a rotor that is rotated relative to the stator;
a stator holder that has a substantially cylindrical shape and that holds the stator at an inner circumferential side;
a housing that has a circumferential wall part at an inner circumferential side into which the stator holder is fitted and that covers outsides of the stator, the rotor, and the stator holder;
a cooling liquid introduction room that is formed between the stator holder and the circumferential wall part; and
a plurality of seal members that are arranged in an outer region of the cooling liquid introduction room with respect to an axial direction of the stator holder between the stator holder and the circumferential wall part,
wherein one of an outer circumferential surface of the stator holder and an inner circumferential surface of the circumferential wall part includes a seal hold part that holds the plurality of seal members,
another of the outer circumferential surface of the stator holder and the inner circumferential surface of the circumferential wall part includes a plurality of raised parts on which the plurality of seal members held by the seal hold part ride and with which the plurality of seal members come into close contact in a compressed state, and
an end portion on one side in the axial direction of at least two of the raised parts and any of the seal members held by the seal hold part are arranged at a position so as not to come into contact with each other simultaneously on a virtual relative displacement trajectory in the axial direction of the circumferential wall part and the stator holder.

2. The rotary electric machine according to claim 1,
wherein in each of a first region between the stator holder and the circumferential wall part, the first region being an outer region on the one side in the axial direction of the cooling liquid introduction room, and a second region between the stator holder and the circumferential wall part, the second region being an outer region on another side in the axial direction of the cooling liquid introduction room, the pair of seal members are spaced apart in the axial direction and are held by each of the seal hold members, and the pair of raised parts with which each of the seal members comes into close contact are arranged, and
an end portion on one side in the axial direction of all of the raised parts and all of the seal members held by the seal hold part are arranged at a position so as not to come into contact with each other simultaneously on the virtual relative displacement trajectory in the axial direction of the circumferential wall part and the stator holder.
